(19) United States
(12) Patent Application Publication
(10) Pub. No.: US 2014/0181330 A1
(43) Pub. Date: Jun. 26, 2014

(54) METHOD, SYSTEM FOR CONFIGURING PERIPHERALS, AND A COMPUTER-READABLE MEDIUM

(71) Applicant: COOLER MASTER CO., LTD., New Taipei City (TW)

(72) Inventors: CARTER SALLEY, Singapore (SG); PAUL LEE SWEE CHANG, Singapore (SG)

(73) Assignee: COOLER MASTER CO., LTD., NEW TAIPEI CITY (TW)

(21) Appl. No.: 13/726,137

(22) Filed: Dec. 23, 2012

(51) Int. Cl. G06F 3/06

(52) U.S. Cl. CPC G06F 3/0634
USPC 710/14

(57) ABSTRACT

Disclosure herein is related to a method and a system for configuring peripherals. In accordance with one embodiment of the invention, the system mainly includes a computer system and one or more peripheral devices connected with the computer system. With the software in the computer system, a user is allowed to configure one or more profiles. The profiles stored in each peripheral device are downloaded from the computer system. The profile records the settings of controlled items of every peripheral device. A switching mechanism configured in the peripheral device allows the computer system to configure the peripheral devices to meet a specific operational environment according to the selected profile. For implementing the invention, the peripheral device is mounted with a profile button used for switching the profiles, a command button for switching the item-to-be-controlled, and a tuning button for detail tuning.

### BACKGROUND OF THE INVENTION

1. Field of the Invention

The present invention is related to a method for configuring a peripheral device, a system thereof, and a computer-readable medium, in particular, to the method and system providing the peripheral device which stores the profiles for configuring the other peripheral devices.

2. Description of Related Art

Based on the framework of the conventional computer system, every peripheral device needs a driver installed in the operating system of the system to communicate with the computer system. The operating system usually initiates a configuration interface allowing the user to do configuration as required. The configuration is such as configuring sensitivity of a computer mouse, response speed of keystroke, or volume of the speaker and microphone. However the configuration is with respect to the hardware, and a driver initiated by an operating system is to conduct the configuration.

Reference is made to FIG. 1A. A computer system 10 is connected with the peripheral devices such as computer mouse 12, keyboard 14, earphone-microphone set 16 and/or speaker via an I/O port 103. The computer system 10 communicates with the internal or external peripheral through the operating system 101 and I/O port 103. The driver installed in the operating system is employed to drive the connected peripheral device, including exchanging information. The operating system thereby drives the peripheral to operate.

Thus, the general computer system 10 is exemplarily installed with a first driver (111) for computer mouse 12, a second driver (112) for conducting keyboard 14 to render signals, and a third driver (113) with respect to the earphone-microphone set 16. Through these drivers, the operating system 101 serves users to manipulate and operate the computer.

Further reference is made to FIG. 1B that illustrates a conventional condition while a custom driver set 105 for the various peripherals is installed into the computer system 10. The basic features of that peripheral product should work (ie. Mouse cursor moves, playback/mic volume level works, etc) normally as expected, but some manufacturers do invest in development of a corresponding set of product drivers to bring out the full potential of their product. For example shown in FIG. 1B, the custom driver set 105 is rather than the default driver(s) (for example 111, 112, 113) existed in the operating system 101. When such the custom driver set 105 is installed into the operating system 101, some more program components can be generated to add on or replace the previously-existed drivers for the various peripheral devices (12, 14, 16).

As shown in the current figure, the new first custom driver 111′, the second custom driver 112′ and the third custom driver 113 appear to replace the original drivers 111, 112, and 113 while the custom driver set 105 is installed. One of the objectives of the added program components is to enable potential functions that the default driver never gives.

In conventional technologies, the user is privileged to configure his preference to single device at one time. The current technologies not yet provide any solution which allows the user to switch the various configurations to multiple peripheral devices at the same time.

### SUMMARY OF THE INVENTION

Integration of profiles is generally introduced to providing a general solution for configuring the peripherals with various setting parameters in accordance with a user's preferences or due to environmental concerns. Disclosure related to the present invention is a method for configuring a peripheral device, a system therefor, and a computer-readable medium for storing the instructions for implementing the method. One main feature is to provide a program installed in a system host for managing the peripheral devices connected with the host. The system records various profiles. A function key is incorporated to allowing a user to switch the profiles based on his preference or any environmental concern.

In one of the exemplary embodiments, the configuration system includes a computer system which prepares a memory for storing one or more system-end profiles. The computer system is connected with one or more peripheral devices. Each peripheral device may have memory to store the profile(s). The profile particularly records setting of one or more controlled items for the one or more peripheral devices. The system allows the user to switch the various profiles while manipulating one of the peripheral devices. Therefore, the peripheral device exemplarily provides a profile button for switching the plurality of profiles, a command button for switching controlled items, and a tuning button for performing function tuning. Further, a display may be mounted on to the peripheral device for displaying the status of configuration.

In one further embodiment in the disclosure, the system for configuring the peripheral device includes a control program installed in the computer system. The control program is served to drive the peripheral device(s). The memory of computer system stores the system-end profile(s). In the current example, the peripheral device is controlled by the control program. The peripheral device may include a control unit for managing the circuit units and signaling. A memory unit may also be included for storing one or more profiles or profile links for linking the profiles. The peripheral device may also include a communication unit for communicating with the computer system, and an input unit for switching the in-device profiles. In addition to switching the profiles, the device includes the means for switching the controlled items and tuning means therefor.

The mentioned means for switching the profiles is configured to provide a profile button that is allowed for the user to switch the profiles. The means for switching the controlled items is implemented by a command button that is for switching the controlled item. Further, the tuning function is set as a tuning button.

For example, when the peripheral device is a computer mouse, the profile button is such as a first button of the mouse, the command button is such as a second button, and the mouse roller is configured to tune the controlled item. In one further example, when the peripheral device is a keyboard unit or an audio input/output device, the mentioned profile button is a first button mounted on the device, the command button is a second button, and the tuning button is such as a knob or a volume knob in the audio input/output device.

The embodiment made to the method for configuring the peripheral device includes initializing computer system and its connected one or more peripheral devices. The method is also to initiate a control program of the computer system for acquiring information of the peripheral devices. After the user manipulates the peripheral device, a control signal is generated and received by the control program through the system's I/O port. The driver of the device then translates the control signal so as to obtain a control instruction. In response to the control instruction, a profile or a profile link stored in the peripheral device may be retrieved based on a comparison. Thus the control program is configured to drive the peripheral device according to the retrieved profile.

### BRIEF DESCRIPTION OF THE DRAWINGS

The accompanying drawings which are incorporated in and which constitute a part of this specification illustrate several exemplary constructions and procedures in accordance with the present invention and, together with the general description of the invention given above and the detailed description set forth below, serve to explain the principles of the invention wherein:

FIG. 1A and FIG. 1B show schematic diagrams illustrating the connections between a computer system and peripheral devices in the conventional technology;

FIG. 2 shows a schematic diagram of a configuration system for the peripheral devices in an embodiment of the present invention;

FIG. 3 shows circuit blocks of the peripheral device applied with the configuration method in an embodiment of the present invention;

FIG. 4 schematically shows the peripheral device applied with the configuration method in first embodiment of the present invention;

FIG. 5 schematically shows the peripheral device applied with the configuration method in second embodiment of the present invention;

FIG. 6 schematically shows the peripheral device applied with the configuration method in third embodiment of the present invention;

FIG. 7 schematically shows the peripheral device applied with the configuration method in fourth embodiment of the present invention;

FIG. 8 shows a schematic diagram of the configuration system for the peripheral devices in one embodiment of the present invention;

FIG. 9 shows a flow chart illustrating the configuration method for the peripheral devices in one embodiment of the present invention;

FIG. 10 shows a flow chart illustrating the configuration method for the peripheral devices in one further embodiment of the present invention;

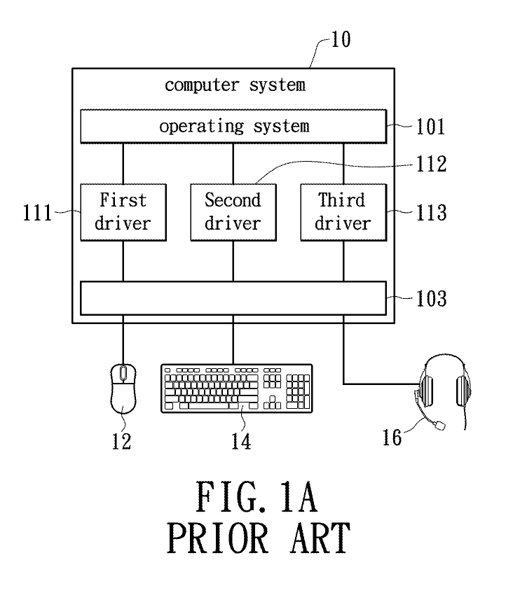

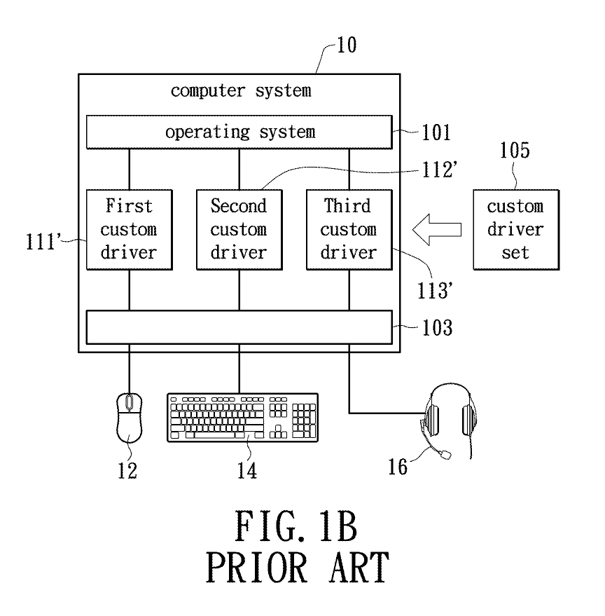

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In accordance with the embodiments of the present invention, disclosure is related to a method and system for configuring the peripheral devices. The system is provided integrate the peripheral devices which are connected with a computer system. The peripheral device is such as a keyboard, a mouse, a headphone, or any other device which is allowed to dispose a button, display and I/O control. Furthermore, the invention is also applied to the hardware in addition to the mentioned peripherals. For example, the system of the present invention may be applicable to a housing unit of the computer system. In which, the housing unit may be configured to regulate the illuminations or the heat-dissipation fan mounted on the surface thereof.

In an exemplary example of the invention, the computer system is installed with a control program which integrates the drivers for the various peripheral devices and their settings. The control program is stored in a storage medium of the computer system. The control program may be operated as a daemon in the memory when it is initiated. The control program may also serve to provide a user interface for the user to conduct setting, storing, or modifying the parameters for the peripheral devices more conveniently. In particular, the profiles stored in the system or peripheral device(s) may be modified to add new or delete.

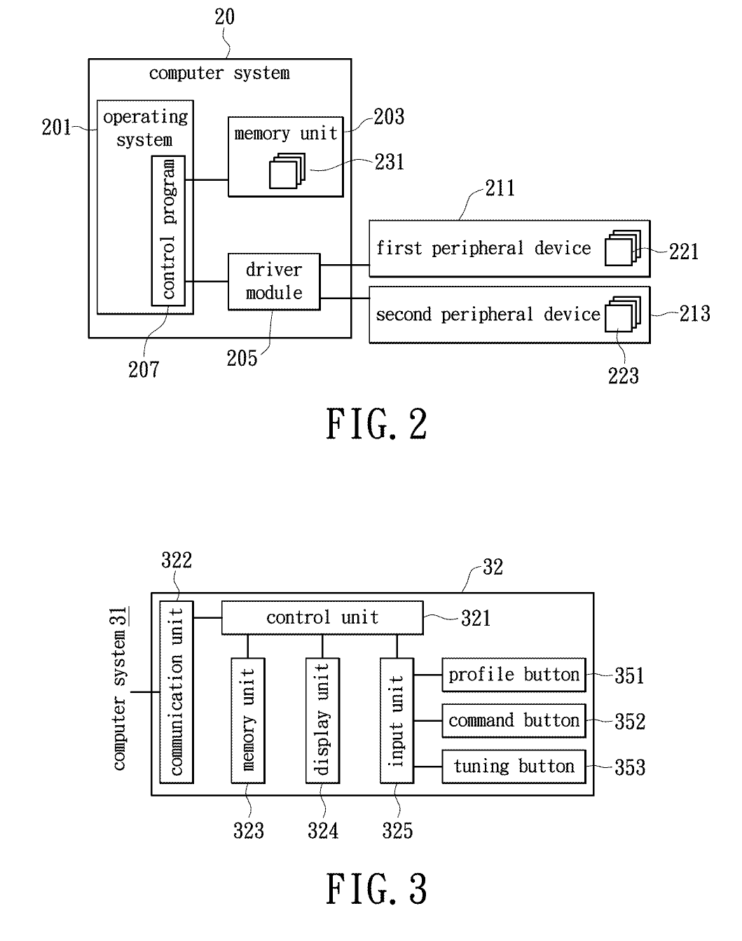

FIG. 2 shows a relevant embodiment of the configuring system for the peripheral device(s).

A shown computer system 20 is installed with an operating system 201, which is operated to communicate with the peripheral devices (211, 213) in addition to the system's operation. A control program 207 is installed in the operating system 201 and is provided to integrate the driver(s) of the peripheral device(s).

In one embodiment, the control program 207 is used to control and configure the peripheral devices (211, 213) which are connected with the computer system 20. The control program 207 is configured to render a graphic user interface (GUI) allowed to add, update, store or delete the profile(s) of one or more peripheral devices.

In this diagram, the computer system 20 includes a memory unit 203. In addition to have the requisite programs for operating the computer system 20, the memory unit 203 is particularly used to store the mentioned control program 207, the one or more profiles, and the drivers prepared for the various peripheral devices.

The operating system 201 uses a driver module 205, which is installed in the system 20, to drive a first peripheral device 211 and a second peripheral device 213. When the system 20 boots up, the operating system 201 executes any driver in response to the initial instruction by the driver module 205. The driver module 205 is configured to initiate the instruction or interface for driving the corresponding peripheral device.

In accordance with one of embodiments of the present invention, one of the objectives is to provide a function allowing the every peripheral device (211, 213) to store configurable settings for each other. The control program 207 in the system 20 is served to create the system-end profile(s) 231, which is stored in the memory unit 203. The system-end profile 231 made by the control program 207 is based on the user's preference or default value of the system.

According to the present example, both the first peripheral device 211 and the second peripheral device 213 have memories. The memory in the peripheral device is used to record the profile, such as the first profile 221 and the second profile 223, acquired from the mentioned system-end profile 231 in the computer system 20. In one further embodiment of the present invention, the peripheral device records one or more profile links correspondingly linking one or more profiles in the system 20. A lookup table may be introduced therefore.

It is noted that both the system-end profile 231 in the system 20 and the profiles 221, 223 stored in the peripheral device(s) are the integrations including parametric settings for the one or more peripheral devices. The parametric settings are configured to correspond to various specified purposes or to user's preference. The functions submitted in accordance with the present invention are performed through the control program installed in the computer system. A plurality of profiles is available to the user's operations.

For achieving the objectives of the invention, the peripheral device applicable to the present invention may be technologically equipped with a memory. The memory stores the one or more profiles (231), made by the control program 207 in the computer system (20), which are with respect to the operational environments and downloaded from the computer system (20). In one further aspect of the invention, in the memory of the peripheral device one or more profile links are stored. Several related functional buttons may be disposed in the peripheral device(s) for switching the profiles.

The claimed system in accordance with the present invention allows the control program 207 to integrate the configurations of the peripheral devices (211, 213) connected with the computer system, and particularly to apply the settings to each other. The main purpose of the system-end control program 207 is to coordinate the every peripheral device's driver which allows the program 207 to acknowledge the instructions from the every peripheral device (211, 213). By the driver, the control program 207 is allowed to drive the peripheral device. The control program also controls the one or more system-end profiles that stored in the memory. The system-end profile is to be the source which serves the every peripheral device to download the profile(s).

When the computer system receives instruction with respect to profile specified by the user's operation using the profile button on peripheral device (211, 213), the control program (207) is to drive the peripheral device (211, 213) according to the specified profile. After that, the corresponding peripheral device (211, 213) is set up responsive to the parameters recorded in the profile. The peripheral device incorporating the mechanism should include a memory to store one or more profiles or any profile link mapping the profile. The memory is preferably a flash memory. The specifications to the profile button, command button, and any rotatable component for conducting the configuration or tuning will be described as follows.

In an exemplary example of a computer mouse, the profile with respect to the computer mouse may relate to “dots per inch” (DPI) that represents the resolution of the optical element of the computer mouse. Multi-segment configurations of DPI may be applied to a function button of a specific peripheral device such as, but not limited to, the computer mouse. Some further controlled items of the computer mouse are such as “Lift-Off-Distance” (LOD) which sets up the sensitivity while the computer mouse travels over a surface with various roughness and “polling rate” that indicates the frequency per second of the signals sent from the computer mouse to the computer host.

In addition to the major parameters related to the computer mouse, the function buttons thereon are applicable to set up the profile links to the other peripheral devices connected with the same computer system. For example, a rotatable element such as the mouse roller is configured to tune the volume, tone quality and sound equalization of the headphone or speaker. Further, the rotatable element is also applicable to adjust color temperature and brightness of the lamps set onto the computer housing or keyboard. The rotation speed of heat-dissipation fan is also tunable by the same means.

Refer to the embodiments of above-mentioned computer mouse; one profile is a set including one or more setting parameters for the user to configure the various peripheral devices. For example, the one peripheral device is configured to set the computer mouse to be with a specific DPI, LOD and polling rate, the headphone to have volume, and also the computer housing to be with brightness of lamp and rotating speed of fan while switching to one of the profiles. Further, some temporary fine tunings are also operative to operate in coordination with other function buttons or rotatable elements. After the fine tunings, the related settings are to be one new stored profile.

For example, the preferred DPI and LOD for computer mouse, volume and bass setting for headphone or speaker, and key response of keyboard are well set while the corresponding profile is selected for performing computer game. Still further, for general paperwork, one other profile is switched since the paperwork needs different operational environment. When the settings are modified by the user's temporary tunings in condition for specific operational environment, for example amplifying the volume, the original setting may still be recovered at next switching if the modification is not saved to the profile.

According to hardware design, the peripheral device such as computer mouse, keyboard, headphone or computer housing may be disposed with function selection keys or tuning buttons as switching to one of the profiles or fine tuning.

Reference is made to the embodiment shown in FIG. 3 illustrating the circuit blocks of the peripheral device applied to the claimed configuration method.

A peripheral device 32 connected with a computer system 31 is shown. The peripheral device 32 is such as a keyboard, a computer mouse, an headphone, a housing unit, or any drivable and configurable I/O device. The peripheral device 32 is disposed with a control unit 321 for managing the signals among the circuit units. Some other circuit units electrically connected to the control unit 321 are exemplarily disclosed, for example a communication unit 322, a memory unit 323, a display unit 324, and input unit 325, and the key units. The key units are preferably the shown profile button 351, command button 352 and tuning button 353.

Through the communication unit 322, the peripheral device 32 is communicated with the computer system 31 by means of wireless or wired connection. The memory unit 323 is an essential component of the peripheral device for performing the configuring method. The memory unit 323 is rendered to record the profiles provided by the computer system 31. The profiles are preferably loaded from the one or more system-end profiles stored in the computer system 31. The profiles stored in the specific peripheral device 32 are preferred to have the relevant features. For example, the control functions made by computer mouse are specified because of the mouse roller. That means the controls are associated to the feature of the mouse roller. Because the keyboard has keys, the profiles stored in the keyboard may be preferred to correspond to its own feature.

The display unit 324 is an optional component. The peripheral device may still be applicable to the present invention since it has no display. When the peripheral device 32 is disposed with the display unit 324, the display unit 324 may prompt the current status of configurations, or show the peripheral device to be currently controlled and the related functions. For example, the display unit 324 may prompt the current configuration through the indications made by lamp's color, brightness, or relevant measures. The display unit 324 may be implemented by LCD or other display capable of showing rich contents. Texts or images may be used to represent the contents.

The input unit 325 of the peripheral device 32 may be the originally-equipped keys, knobs, touch pad or the like of the device 32. However, any newly-added input device for the applications of the invention is also applied. Both the originally-equipped input devices and the newly-added keys embody the input unit 325 applicable to conduct switching the profiles, controlled items and tuning functions. In an exemplary example, the peripheral device 32 may be disposed with the shown profile button 351, command button 352 and tuning button 353, which are associated with the input unit 325.

The profile button 351 is used to switch the profiles for the peripheral devices. The command button 352 is used to switch the controlled items for each selected profile. The tuning button 353 is used to tune the functions related to the selected controlled item. Since the every profile has stored setting of the various controlled items for the different peripheral devices, the setting made by the tuning button 353 may be temporary. However, the control program (207 in FIG. 2) may be used to store the temporary state which is to be new or replace the previous setting. The temporary setting may be recovered to the previous one when the system is rebooted or switched to another state with respect to any other profile.

It is noted that the peripheral device may embody the profile button 351, command button 352 and the tuning butting 354 by using its original input device or newly-added key. However, the instructions for configuring, commanding, and tuning made by the profile button 351, command button 352, or/and tuning button 353 may be executed by other input means. For example, a combo key capable of rotating and clicking may be used in place of the combination of the three buttons. Further, software keys instructed by a touch panel may embody the three buttons. All the described input methods are to switch the profiles, controlled items, and tune the selected controlled item in response to the control instruction.

### First Embodiment

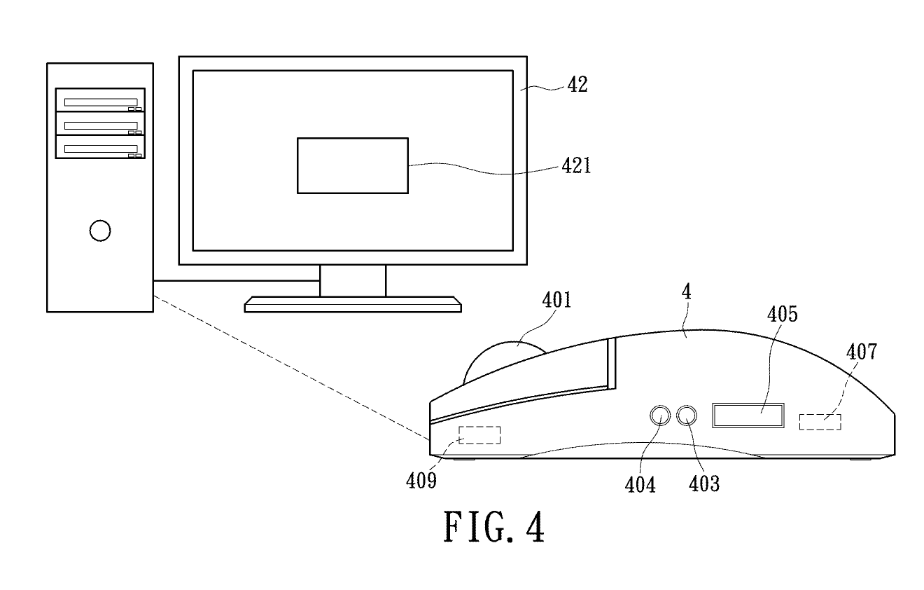

The peripheral device is such as a computer mouse. The computer mouse may be controlled with configurations including polling rate, DPI, LOD, light source, and button assignment. The hardware may be referred to the diagram shown in FIG. 4.

The computer mouse 4 may have a communication interface 409 which is served to communicate with a computer system. Both wireless or wire connection may implement the communication. Via the communication interface 409, the computer mouse 4 is able to receive driving instruction from the computer system. The computer mouse 4 includes a memory 407 in particular for storing one or more profiles or the information recording the settings of peripheral device(s).

A rotating device is disposed onto the computer mouse 4. The rotating device is such as a roller 401 originally for scrolling the pages on the computer screen. Further, in accordance with the embodiment of present invention, a first button 403 and a second button 404 are disposed on the computer mouse 4. The first button 403 is such as a profile button for switching the profiles. The second button 404 is such as a command button for switching the controlled items with respect to the selected profile. With the implementation of a mouse roller 401, the device is allowed to tune the detail of the selected controlled item by a tuning button. Those buttons or keys allow the peripheral device to reach the objective of the invention.

The computer mouse 4 further includes a display 405 for prompting the configurations. That is the selected profile, controlled item or the detail may be displayed on the display 405 through lamps, icons or other prompts. Otherwise, a display screen 42 of the computer system connected with the computer mouse 4 having no display may be used to display the status. In the present case, the display screen 42 has a display area 421 used to express the settings. The display area 421 is exemplarily created by the control program.

The mentioned mouse roller 401, the first button 403, and the second button 404 are provided for the user to operate the computer mouse 4 for conducting configurations of the mouse 4 itself and the other peripheral device(s). The computer system receives the key code made by the computer mouse 4 via a communication interface 409. The key code is translated by a driver and as to generate control instructions. Settings related to the control instructions are converted into driving instructions. The driving instructions are transferred to the related peripheral device(s) for performing the corresponding settings. A profile may record the settings of plural peripheral devices. Once the selected profile is initiated, the many peripheral devices are accordingly driven to reach the configurations according to the profile.

In an exemplary example, by the profile button, the computer mouse 4 is provided to switch the profile recording the settings for the peripherals. The command button, knob or a wheel member such as the mouse roller 401 is for tuning the detail. One button may implement the profile button to switch the profiles by recurring operations. If the switching numeral is “1”, it is indicated that a first profile is on. Further, the numeral “2” indicates a second profile is selected. Numeral “3” associates with a third profile. When constantly clicking the profile button, the numerals “1”, “2” and “3” are sequentially changed. The changed numerals individually correspond to the first, second and third profiles. It is noted that the shown keys embody the configuring method. This invention may, however, be embodied in many different forms and should not be construed as limited to the embodiments set forth herein.

The above-described embodiment shows the profile button or the like of the computer mouse 4 being switched to a specific value with respect to the selected profile. In the meantime, the control program may accordingly drive the relevant peripheral device(s) due to the setting parameters. The user may afterwards operate the command button or the like to select one of the controlled items. The tuning button or the similar means is provided to adjust or temporarily tune the detail such as volume or brightness.

It is worth noting that the configuring method for the peripheral devices provides much more, flexible and expandable operational environment. For example, at least 24 settings in combination may be provided in an embodiment when there are four peripheral devices connected with the computer system and each peripheral device includes six adjustable functions.

### Second Embodiment

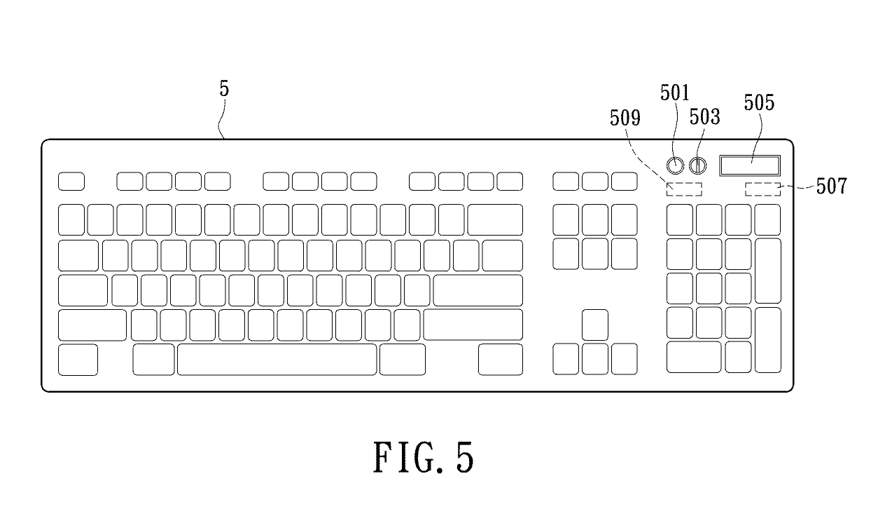

Reference is made to FIG. 5 schematically showing a keyboard unit employing the claimed method for configuring the peripheral device(s). In this example, the keyboard unit 5 is equipped with a memory 507 for storing one or more profiles loaded from its connected computer system. A communication interface 509 is provided to conduct wireless or wired connection to the computer system.

Even though the keyboard unit 5 inherently has a plurality of keys, one new key may still be added for embodying the profile button such as the first button. The profile button in accordance with the present invention is used to switch the profiles stored in the memory 507. The newly-added key 501 may not exclude to be the keyboard's inherent key or combined keys for implementing the same functions.

The keyboard unit 5 may use the keyboard's any key to be the second button, such as the control key “Ctrl”, shift key “Shift”, alternate key “Alt” or function key “Fn”, for embodying the command button. The command button allows the user to switch the controlled item with respect to a selected profile. For example, the controlled items related to the computer mouse may include polling rate, DPI, LOD, light source and key definitions.

The keyboard unit 5 may also be equipped with a knob 503. The knob 503 embodies the tuning button. While a controlled item is selected by the key 501 or any specific key, the knob 503 may be used to tune the setting parameters to the controlled item. A display 505 mounted on the keyboard unit 5 may use lamps, colors, or icons to denote the current profile, controlled item and detail tuning.

The configuration for the keyboard unit 5 is such as the polling rate, key backlight, or definition of function key. For example, the default value can be set as “1”. The value “1” corresponds to one of the profiles. While the key 501 (the first button) is stroked once, it denotes switching the profiles one time. If the value is set to “2”, it shows a next profile is switched. While the key 501 is stroked for many times, the profiles are repeatedly switched for the many times. The display 505 may be used to show the status of the current configuration. Numerals, English letters, LED colors, or/and icons are the forms to indicate the status through the display 505.

Next, the specified controlled item is tuned. Any key of the keyboard unit 5 may conduct the tuning according to key definition. For example, the alternate key (Alt) may embody the tuning button. Alternatively, a newly-added key (the second button) may be used to switch the controlled item. When the “Alt” key or the second button is stroked for one time, one of the controlled items is switched. After one adjustable item is selected, the knob 503 or other function key may be used to conduct tuning. For example, the volume of a headphone may be the controlled item, and the knob 503 or other key is used to tune the volume. After stroking the second button once again, the DPI may be the controlled item allowing the user using the knob 503 to tune the DPI. The signals with respect to the settings are delivered to the computer system over a communication method. The control program receives the signals and translates the signals into the parameters for driving the peripheral. The driver may complete the configuration.

If the keyboard unit 5 has no display 505, the control program of the computer system may be responsible for prompting the configurations. Further, the control program allows the user to store any new profile(s).

The design of the key mounted on the keyboard unit 5 should not be construed as limited to the embodiment shown in the FIG. 5. LEDs may also embody the display 505 for showing the current configurations.

### Third Embodiment

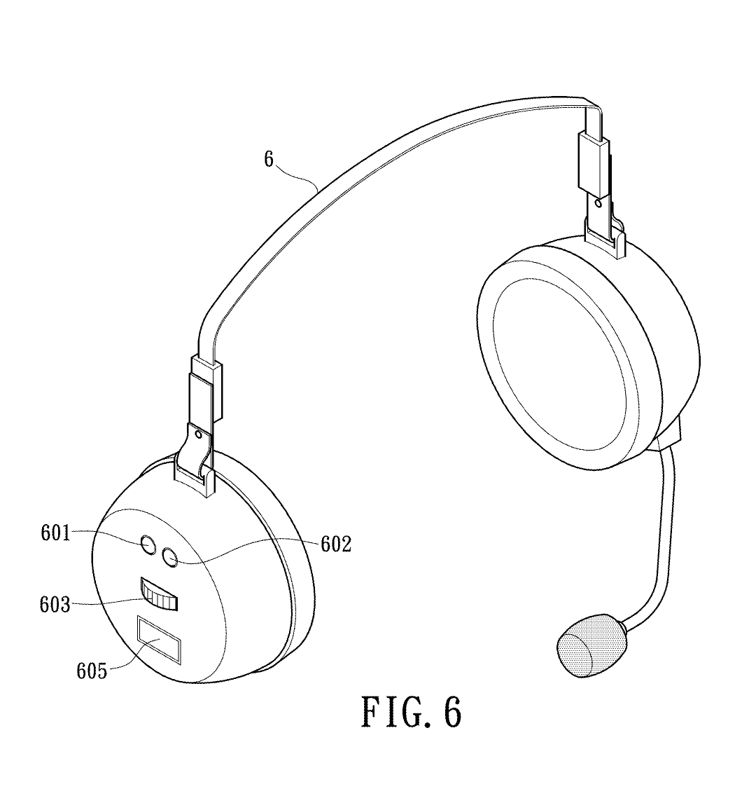

FIG. 6 shows a schematic diagram illustrating the method for configuring audio input/output device. The shown audio input/output device is such as a headphone 6 which is capable of receiving or playing sound. The device may also be the legacy speaker or any audio device. The controlled items related to the headphone 6 or the similar device include audio output channel, output volume, output silent mode, equalizer, microphone volume, input silent mode, auto gain control (AGC) and other sound effects.

According to the aspect of the present invention, there is a first button 601 disposed onto one cup-shaped side of the headphone 6. The first button 601 exemplarily embodies the profile button for switching profiles. A second button 602 may be provided for switching controlled items with respect to the profile. Further a knob 603 is also provided for fine tuning the details. A display 605 may also be provided in order to notify the current configurations.

Similarly, the control program at the system end may be used to prompt the status of the configurations since the headphone 6 has no display 605. The shown button of the headphone 6 may not construe the limitation to the embodiment of the invention. Furthermore, the design of the knob 603 and the display 605 of the headphone 6 should not be construed as limited to the embodiment shown in the FIG. 6.

### Fourth Embodiment

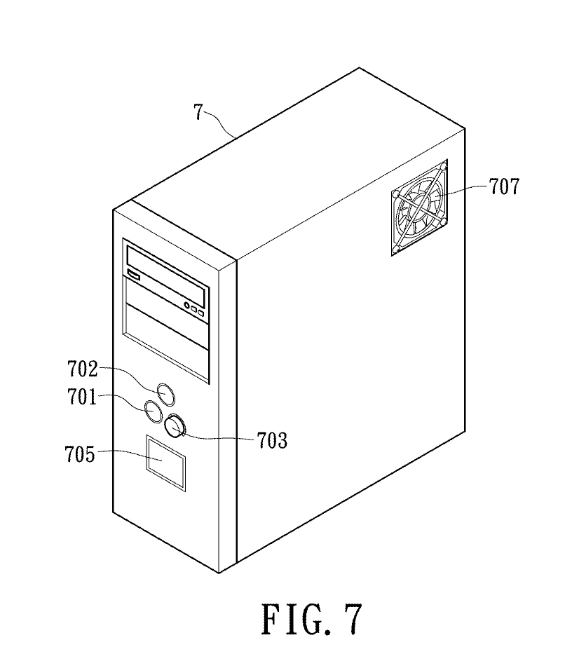

Besides the mentioned legacy peripheral devices, the present invention is also applicable to the device having the memory, communication interface, and the controllable peripheral device. FIG. 7 shows the schematic diagram of a housing unit 7.

The housing unit 7 is such as the housing for a general computer device, or any electronic device. This housing unit 7 is not only a protective shell for the computer system, but also a device capable receiving the control instruction from the computer system since this unit 7 is electrically connected to the system. The housing unit 7 is also able to transmit any instruction. The controlled items on the housing unit 7 include the rotating speed of fan 707 and brightness of its exterior lamps.

Furthermore, this housing unit 7 is equipped with a memory (not shown in this figure) which is provided to store one or more profiles. The housing unit 7 also includes a first button 701 which is used to switch the stored profiles. A second button 702 is also provided thereon for switching the controlled items with respect to the every profile. Further, a knob 703 may be provided for the user to tune the setting for the each controlled item. Still further, the housing unit 7 may be disposed with a display 705 for displaying the status of configurations.

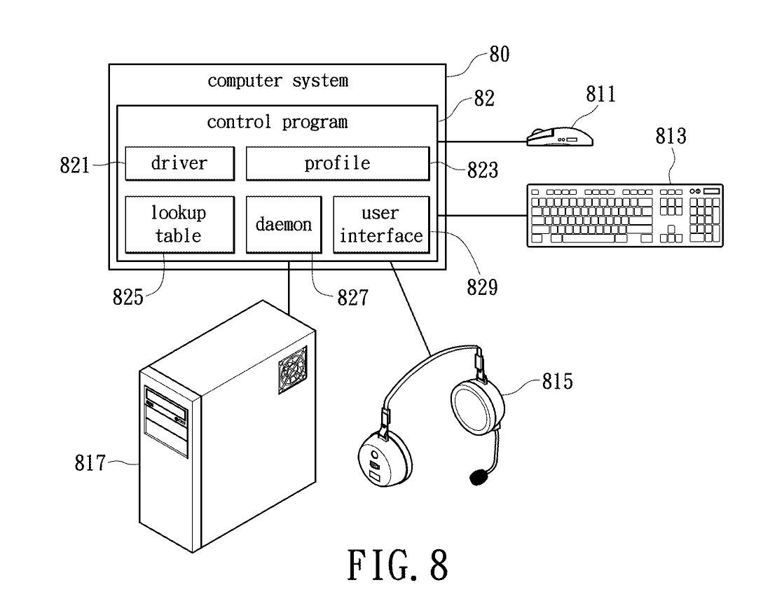

The configuration system shown in FIG. 8 is configured to integrate the above mentioned features for the various peripheral devices.

The shown computer system 80 connects with a plurality of peripheral devices such as the computer mouse 811, keyboard 813, headphone 815 and housing unit 817. These peripheral devices in accordance with the present invention may be equipped with some requisite elements such as the buttons or knob to conduct profile switching, controlled item selecting and the function tuning. It is preferably allowing the user to manipulate the peripheral device using those controllable buttons or knob. Therefore, any profile stored in the peripheral device, made by the user's operation, is applicably used to configure the other peripheral devices simultaneously.

The computer system 80 is installed with a control program 82. Reference is made to FIG. 8; an operating system is initiated as booting up the computer system. The control program 82 is executed to integrate the operations of the peripheral devices. The control program 82 will take over the control privilege for the every peripheral device, and the operating system is to be a platform for the operation of control program 82.

In an exemplary embodiment, the control program 82 includes a daemon 827. The daemon 827 is resided in the main memory of the computer system 80 while the control program 82 is executed. The daemon 827 is anytime listening to the signals from the peripheral devices, and the control program 82 is able to make response instantly.

Further, the control program 82 collects the drivers 821 for the various peripheral devices. The drivers 821 are acquired at the moment as installing the peripheral devices. The operating system of computer system 80 is also a source providing the drivers 821, especially the universal driving programs. One of the objectives of the drivers 821 is to translate the signals generated from the buttons mounted on the peripheral devices. The each proprietary driver is to drive the peripheral device which issues the signals.

The control program 82 further establishes links to the one or more profiles 823 in the memory of computer system 80. The lookup table 825 is in form of a table or database for recording the correlations between the key codes and the various functions. The lookup table 825 is allowed to establish the mapping between the key code sent from the peripheral device and control signal. For example, according to the lookup table 825, the key code of profile button maps the signal indicative of switching profiles, and the other key codes may correspond to the functions to switching the controlled items or the details.

For example, according to content of the lookup table 825, the key code generated from the profile button of the peripheral device corresponds to one of the stored profiles. Further, the key code of command button corresponds to one of the controlled items with respect to the selected profile. Still, the tuning button for tuning the selected controlled item has a key code which is mapped to the tuning function.

The control program 82 is particularly provided for the user to easily operate the user interface 829. This graphic user interface 829 allows the user to acknowledge the information of peripheral device.

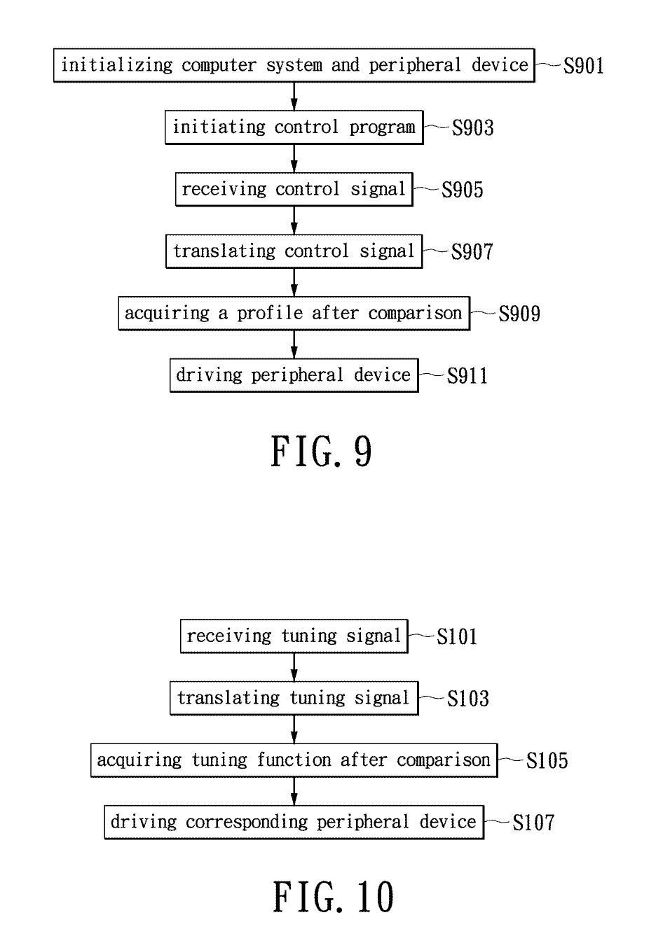

FIG. 9 shows a flow chart of the method for configuring the peripheral devices in accordance with the embodiment of the invention while the above-described system is prepared.

The system is initialized in beginning step S901. The initialization is over the computer system and its one or more peripheral devices. In step S903, a control program may be manually or automatically initiated. The control program then acquires the information of the every peripheral device through the operating system and communication interface. The information is such the state of driver. The information is provided for user to implement the configuration method for the peripheral devices through the control program.

In one aspect of the present invention, a daemon may be created while the control program is initiated. The daemon may listen to message from the every peripheral device anytime. If any control signal is generated as operating the button or similar means provided by the peripheral device, such as step S905, the control program takes over the I/O port of the computer system for receiving the control signals. Further, this control program governs the one or more system-end profiles stored in the computer system. The each peripheral device may download the one or more profiles by this control program.

The mentioned control signals may be obtained from any specific peripheral device. The control program translates the control signals by the proprietary driver (step S907). The corresponding control instructions may be acquired. The control instructions may include the instruction for switching the profiles (step S909). One of the profiles may be obtained according to a comparison. The profile is one of the profiles stored in the peripheral device which issues the control signal. The comparison may result in obtaining a profile link linked to the profile. All of the profiles are preferably stored in the computer system. The control program then drives the peripheral device based on the profile, and also allows tuning the controlled item(s). The profile button or any other switching means is configured to issue the control signal which may map an instruction according to a lookup table. The lookup table records profiles and the related controlled items, and the instructions for tuning the items.

In the example of the corresponding profile, the profile may record settings to one or more peripheral devices. The driver is used to translate the settings into the control signals for driving the peripheral device(s). In step S911, the profile allows the whole computer system and the connected peripheral devices to be in an operational environment in compliance with the profile.

In an exemplary example, the user may operate the computer mouse to tune the other peripheral device. The computer mouse includes an adjustable key or any similar interface for switching the profiles, controlled items or performing tuning. After stroking the profile button for one or more times, one of the profiles can be selected. The computer system may receive the content related to the selected profile. The control program then accordingly drives the peripheral device. For example, the profile is related to a set of parameters such as the DPI of computer mouse, key response of keyboard, volume for the headphone, and/or rotating speed of fan of housing unit. After that, the computer system may be in a specific operational environment based on the configurations of the selected profile. The user therefore is allowed to tune the controlled item. For example, the user may operate the computer mouse to select one of the controlled items by one or more keystrokes to the command button. The tuning item is such as the volume for the headphone in the current case.

The embodiment of steps for tuning the functions may be referred to the flow chart shown in FIG. 10.

A controlled item is selected. For example, the item is such as the volume of headphone. The control program acquires the related information. The control program then takes over the privilege to tune the item. Meanwhile, the user may use a tuning button such as the mouse roller of the computer mouse to tune the volume for the headphone. In step S101, the system receives a tuning signal. The driver translates the tuning signal through the control program, such as step S103. Next, in step S105, the corresponding function to be tuned may be obtained through the translation and comparison. The mouse roller may be the means for tuning the volume be higher or lower level. The control program then drives the peripheral device to reach the user's need (step S107). Therefore, the volume for the headphone can be well tuned.

The present invention is further related to a computer-readable medium which is configured to store the programs for performing the claimed configuration method. The medium is installed in the computer system. The programs are the instructions for executing the control program. The programs are the instructions for performing the claimed method. While the system is initialized, provided is the instructions for acquiring the information of the one or more peripheral devices connected with the computer system. The programs are also the instructions for controlling one or more system-end profiles stored in a memory in response to the signal generated by the peripheral device. The programs include the instructions for receiving the control signals from the one or more peripheral devices. The programs include instructions for issuing the control signals. The method also provides instructions for translating the control signals made by the driver with respect to the peripheral device which issues the signals. Still further, the programs include instructions for acquiring the profile or profile link linked with the profile according to a control instruction. The further instructions are for driving the one or more peripheral devices connected with the computer system.

To sum up the above description, the method and system for configuring the peripheral devices render the peripheral devices to store the profiles. The profiles are provided for the user to configure the other peripheral device(s). The profile includes the setting parameters set based on the user's preference or requirement of operational environment. A switching means is provided to switch the profiles related to the various peripheral devices. Any profile is configured to drive the peripheral device(s) connected to a computer system into an operational environment. The fine tuning allows tuning the detail specified to a controlled item based on the user's preference or requirement.

It is intended that the specification and depicted embodiment be considered exemplary only, with a true scope and spirit of the invention being indicated by the broad meaning of the following claims.

What is claimed is:

1. A system for configuring one or more peripheral devices, comprising:
a computer system, in which a memory is configured to store one or more system-end profiles;
one or more peripheral devices electrically connected with the computer system, in which each peripheral device has memory to store one or more profiles, and each profile is loaded from the one or more system-end profiles in the computer system and the profile records setting of one or more controlled items for the one or more peripheral devices, the each peripheral device comprising:
a profile button, used for switching the profiles, in which the profile button's key code is associated with one profile stored in the one or more peripheral devices;
a command button, used for switching the controlled items, in which the command button's key code is associated with one controlled item of the profile; and
a tuning button, used for tuning function of the controlled item, in which the tuning button's key code is associated with function specified to the controlled item.

2. The system of claim 1, wherein the computer system is installed with a lookup table recording correlations between the key codes of the profile button, the command button and the tuning button, and corresponding functions.

3. The system of claim 1, wherein the peripheral device further comprises a display for displaying controlling status.

4. A system for configuring one or more peripheral devices, comprising:
a computer system installed with a control program, which is configured to have a driver module for driving the one or more peripheral devices, and one or more system-end profiles stored in a memory of the computer system;
one or more peripheral devices electrically with the computer system, controlled under the control program, wherein each peripheral device comprises:
a control unit for managing signals among circuit units in the peripheral device;
a memory unit, electrically connected to the control unit, used for storing one or more profiles, or one or more profile links;
a communication unit, electrically connected to the control unit, for communicating with the peripheral device and the computer system; and
an input unit, electrically connected with the control unit, providing means for switching profiles, means for switching controlled items, and means of tuning function;
wherein, the each profile stored in the memory unit records settings of one or more controlled items for the one or more peripheral devices; the control program is configured to select one profile stored in the peripheral device by means for switching profiles, and select one controlled item corresponding to one peripheral device in the selected profile by means for switching controlled items; and select setting of the selected controlled items by means of tuning function.

5. The system of claim 4, wherein the peripheral device further comprises a display unit for displaying status of configuration.

6. The system of claim 4, wherein, on the peripheral device, a profile button is provided to switch profiles, a command button is provided to switch controlled items, and a tuning button is provided for tuning function for the controlled item.

7. The system of claim 6, wherein the peripheral device is a computer mouse, in which the profile button is a first button, the command button is a second button, and the tuning button is a mouse roller of the computer mouse.

8. The system of claim 6, wherein the peripheral device is a keyboard unit, in which the profile button is a first button, the command button is a second button, and the tuning button is a knob.

9. The system of claim 6, wherein the peripheral device is an audio input/output device, in which the profile button is a first button, the command button is a second button, and the tuning button is a knob.

10. The system of claim 4, wherein the control program is a daemon resided in the computer system after execution.

11. The system of claim 10, wherein the control program further provides a user interface for user's manipulation.

12. The system of claim 4, wherein the one or more profiles stored in the peripheral device are loaded from the system-end profiles in the memory of the computer system.

13. A method for configuring one or more peripheral devices, comprising:
initializing a computer system and the one or more peripheral devices which are connected with the computer system;
a control program acquiring information related to the one or more peripheral devices as initiating the control program installed in the computer system, wherein the control program is configured to have one or more system-end profiles;
the control program receiving a control signal issued from the peripheral device connected with the computer system through an I/O port of the computer system and operation of an operating system;
translating the control signal for obtaining a corresponding control instruction; and
in response to the control instruction, acquiring a profile or a profile link for linking the profile stored in the peripheral device, and the control program driving the peripheral device correlated with the profile.

14. The method of claim 13, wherein the control program translates the control signal through a driver installed in the computer system, and the driver is used to drive the peripheral device issuing the control signal.

15. The method of claim 13, wherein, in response to the control instruction, the profile or the profile link and a controlled item of the profile is acquired.

16. The method of claim 15, wherein the control instruction includes a tuning function for the controlled item.

17. The method of claim 16, wherein the control signal is a key code issued from the peripheral device.

18. The method of claim 17, wherein the key code is from a profile button configured to switch profiles; or from a command button configured to switch controlled items; or from a tuning button for tuning function.

19. The method of claim 13, wherein the profile stored in the peripheral device is loaded from one or more system-end profiles stored in a memory of the computer system.

20. A computer-readable medium, including instructions executed in a computer system for performing a method for configuring one or more peripheral devices, wherein the instructions include:
instruction for acquiring information of one or more peripheral devices connected with the computer system;
instruction for controlling one or more system-end profiles stored in a memory of the computer system;
instruction for receiving a control signal issued from one or one of the peripheral devices;
instruction for translating the control signal by a driver corresponding to the peripheral device issuing the control signal, and forming a control instruction;
instruction for, in response to the control instruction, acquiring a profile or a profile link linking the profile stored in the peripheral device; and
instruction for driving the one or more peripheral devices.
